(19) United States
(12) Patent Application Publication
(10) Pub. No.: US 2011/0065834 A1
(43) Pub. Date: Mar. 17, 2011

(54) ENCAPSULATED PIGMENT PARTICLES

(76) Inventors: Sivapackia Ganapathiappan, Los Altos, CA (US); Howard S. Tom, San Jose, CA (US)

(21) Appl. No.: 12/557,979

(22) Filed: Sep. 11, 2009

(51) Int. Cl. C08K 9/10

(52) U.S. Cl. 523/205

(57) ABSTRACT

An encapsulated pigment particle includes a pigment particle core and a polymer encapsulation layer established on a surface of the pigment particle core. The polymer encapsulation layer includes a polymer and a hydrophobe integrated with the polymer. The hydrophobe has the following structure:

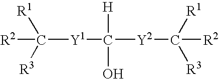

wherein R¹ and R² are independently selected from H, a linear or branched alkyl group with its number of carbons ranging from 1 to 40, and an aryl group with its number of benzene rings ranging from 1 to 10; wherein R³ is H or OH; wherein Y¹ is selected from a bond, 0, a linear or branched alkylene group with its number of carbons ranging from 1 to 40, and an arylene group with its number of benzene rings ranging from 1 to 10; and wherein Y² is selected from a bond and (CH₂)ₙ, where n=0 to 40.

### BACKGROUND

The present disclosure relates generally to encapsulated pigment particles.

Many inks and toners used in the printing industry employ water insoluble polymers for print adhesion and durability. Water-based inks, such as those used in ink-jet printing, can incorporate water insoluble polymer as dispersed particulates. The particulates selected may have a glass transition temperature (T_{g}) near room temperature to allow formation of a print-film on the printed substrate under normal ambient conditions. Alternatively, the water insoluble polymers are coated on the surface of pigments in the form of polymer-encapsulated pigments.

### DETAILED DESCRIPTION

Embodiments of the encapsulated pigment particles disclosed herein include hydrophobes (i.e., co-stabilizers) physically present with the polymer layer as a single or uniform phase established on the pigment core. Such hydrophobes are branched or unbranched compounds including multiple hydroxyl groups, or are branched compounds containing a single hydroxyl group. These particular hydroxyl containing hydrophobes advantageously enable the polymer coating to fully encapsulate the pigment particle core, and the resulting encapsulated particles are relatively thick (which leads to improved durability of the film formed from an ink incorporating such particles). Due, at least in part, to the compatibility of the hydrophobes with the polymer, the addition of the hydrophobes to the polymer layer does not deleteriously affect the properties of the polymer.

Furthermore, most of the hydrophobes disclosed herein are solid materials at ambient temperatures. After encapsulation of the pigment core particles, these compounds become an integral part of the encapsulated particle (i.e., no chemical bond is present between the polymer layer and the hydrophobe, but rather the hydrophobe is physically present with the polymer layer). The solid form of the hydrophobes reduces their mobility, and thus the hydrophobes are less likely to leach from the encapsulated particles. This is in sharp contrast to liquid materials, which can relatively easily leach from encapsulated particles.

Very generally, the polymer encapsulated particles include a pigment particle core and a polymer encapsulation layer established on a surface thereof.

In an embodiment of the method of making such polymer encapsulated particles, pigment particle cores are initially dispersed in water.

The pigment particle core includes any color-imparting particulates. Such color-imparting particulates may be self-dispersed pigments, dispersant-dispersed pigments, raw pigments, etc. Self-dispersed pigments include those that have been chemically modified at the surface with a charge or a polymeric grouping. This chemical modification aids the pigment in becoming and/or substantially remaining dispersed in a liquid vehicle (e.g., an ink vehicle, as described hereinbelow). A non-self-dispersed pigment (i.e., a dispersant-dispersed pigment) requires a separate and unattached dispersing agent (e.g., polymers, oligomers, surfactants, etc.) in the ink vehicle and/or physically coated on the surface of the pigment in order to aid the pigment in becoming and/or substantially remaining dispersed in a liquid vehicle. Applicable pigments have a size less than 500 nm, which is particularly desirable when such pigments are to be dispersed in water.

Other particulates that may be used in addition to the pigments include semi-metal and metal particulates, semi-metal oxide and metal oxide particulates, dispersible silicates and glass particulates, ferromagnetic and other magnetic particulates, whether or not such particulates impart color.

The dispersion of pigment particle cores in water may also include one or more surfactants. Suitable surfactants may be non-ionic, anionic, cationic, or amphoteric in nature. Non-limiting examples of non-ionic surfactants include LUTENSOL® AT50 or AT150 (BASF Corp., Florham Park, N.J.) and those in the SOLSPERSE® series (Lubrizol Corp., Wickliffe, Ohio). Non-limiting examples of anionic surfactants include sodium dodecylsulfate, sodium dioctylsulfosuccinate, and sodium dodecylbenzenesulfonate. Non-limiting examples of cationic surfactants are cetyltrimethylammonium bromide and tetrabutylammonium bromide. A non-limiting example of an amphoteric surfactant is N-dimethyl-N-dodecylglycine betaine. In general, the amount of surfactants present (with respect to the total weight of the pigment dispersion) ranges from 3 wt % to 40 wt %. In other examples, the surfactant amount (with respect to the total weight of the pigment dispersion) ranges from 10 wt % to 25 wt %, or from 15 wt % to 20 wt %. A mixture of different surfactants may also be used (e.g., two different cationic surfactants may be used together, or a non-ionic surfactant may be used with an anionic surfactant).

It is to be understood that the amount of water used for the pigment dispersion will depend, at least in part, upon the amount of pigments to be dispersed.

In one embodiment of the method, a monomer mixture is added to the pigment particle dispersion. Upon being added to the water based dispersion, the monomer mixture will emulsify and become the discontinuous phase in the pigment particle dispersion.

The monomer mixture includes at least one hydrophobic monomer, at least one acidic monomer, and at least one hydrophobe.

The hydrophobic monomer(s) of the latex particles may be present in an amount up to 99.9 wt % of all of the monomers forming the monomer mixture. In alternate embodiments, the hydrophobic monomer(s) may be present in an amount ranging from about 70 wt % up to 98 wt %, or from about 80 wt % up to 98 wt % of the monomers. Non-limiting examples of suitable hydrophobic monomers include methyl methacrylate, ethyl methacrylate, propyl methacrylate, butyl methacrylate, hexyl methacrylate, 2-ethylhexyl methacrylate, lauryl methacrylate, octadecyl methacrylate, isobornyl methacrylate, vinyl acetate, methyl acrylate, ethyl acrylate, propyl acrylate, butyl acrylate, hexyl acrylate, 2-ethylhexyl acrylate, lauryl acrylate, octadecyl acrylate, isobornyl acrylate, styrene, methylstyrene or other substituted sytenes, vinylbenzyl chloride, and combinations thereof. Further, mixtures of the monomers may be used to adjust the glass transition temperature (T_{g}) of the resulting composite polymer layer for film forming ability and the effectiveness of the printed coating composition. In one embodiment, the monomers are selected so that the T_{g} of the resulting polymer ranges from about −40° C. to +125° C., or from 0° C. to 75° C., or from 35° C. to 50° C.

The acidic monomer(s) may be present in an amount ranging from about 0.1 wt % to about 30 wt % of all of the monomers forming the monomer mixture. In alternate embodiments, the acidic monomer(s) may be present in an amount ranging from about 0.5 wt % to about 20 wt %, or from about 0.5 wt % to about 5 wt % of the monomers forming the latex polymer particles. Non-limiting examples of suitable acid-containing monomers include acrylic acid, methacrylic acid, itaconic acid, maleic acid, vinyl benzoic acid, styrenesulfonates, or derivatives thereof (e.g., methacryloyloxyethyl succinate, 2-carboxyethyl acrylate, and 2-carboxycinnamic acid), or combinations thereof.

The acidic monomer(s) may advantageously provide stability to the pigment particles so that they are more stable in water. More particularly, the acidic monomer(s) incorporate charges to the particles, which contribute to their stability. The charge of the particles may be further enhanced by raising the pH of the medium on which the ink and the coating composition will be established to convert —COOH functional groups of the acid into a salt form.

In the embodiments disclosed herein, the monomer mixture includes one or more hydrophobes having the following structure:

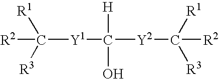

with R¹ and R² being independently selected from H, a linear or branched alkyl group with its number of carbons ranging from 1 to 40, and an aryl group with its number of benzene rings ranging from 1 to 10; wherein R³ is H or OH; with Y¹ being selected from a bond, 0, a linear or branched alkylene group with its number of carbons ranging from 1 to 40, and an arylene group with its number of benzene rings ranging from 1 to 10; and with Y² being selected from a bond and (CH₂)ₙ, where n=0 to 40. Specific examples of such hydrophobes include:

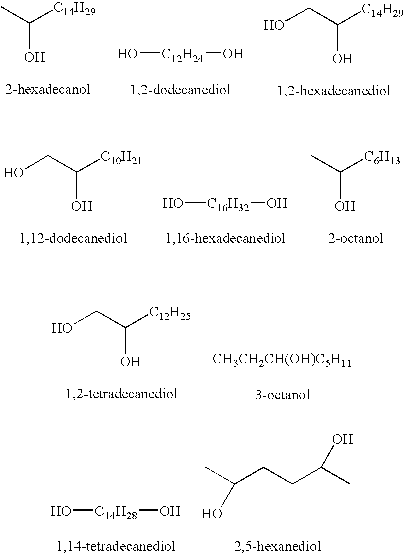

These alcohol containing hydrophobes are mixed with the monomer mixture prior to emulsification so as to prevent phase separation. Furthermore, it is believed that the addition of the hydroxyl containing hydrophobes having the base structure shown above contributes to obtaining thicker encapsulated pigment particles (e.g., ranging from about 2 nm to about 100 nm). Other co-stabilizers (e.g., hexadecane) result in much thinner polymer encapsulation layers, which lead to poor print properties and reduced durability.

Furthermore, the hydrophobes disclosed herein become an integral part of the polymer encapsulation layer, and thus yield a substantially uniform surface. If liquid type hydrophobes are used, they tend to migrate out of the polymer phase, which contributes to the formation of porous structures (which also leads to reduced durability and poor printability).

In some embodiments, it may also be desirable to include a copolymer in the monomer mixture. The copolymer may be prepared using at least one of the monomers of the monomer mixture, all of the monomers of the monomer mixture, and/or only the monomers of the monomer mixture. Examples of incorporating a copolymer in the monomer mixture are disclosed in U.S. Pat. No. 7,544,418, issued Jun. 9, 2009, to Vincent et al., the contents of which is incorporated herein by reference. It is believed that the addition of the copolymer may raise the viscosity of the monomer mixture in a manner sufficient to increase the thickness of the final polymer encapsulation layer.

The monomer mixture may also include one or more surfactants. Suitable surfactants may be non-ionic, anionic, cationic, or amphoteric in nature. Non-limiting examples of non-ionic surfactants include LUTENSOL® AT50 or AT150 (BASF Corp., Florham Park, N.J.) and those in the SOLSPERSE® series (Lubrizol Corp., Wickliffe, Ohio). Non-limiting examples of anionic surfactants include sodium dodecylsulfate, sodium dioctylsulfosuccinate, sodium dodecylbenzenesulfonate, and those in the RHODAFAC® RS series (Rhodia Chimie Corp., France). Non-limiting examples of cationic surfactants are cetyltrimethylammonium bromide and tetrabutylammonium bromide. A non-limiting example of an amphoteric surfactant is N-dimethyl-N-dodecylglycine betaine. In general, the amount of surfactants present (with respect to the total weight of the monomer mixture) ranges from 0.3 wt % to 5 wt %. In other examples, the surfactant amount (with respect to the total weight of the monomer mixture) ranges from 1 wt % to 3 wt %, or from 1.5 wt % to 2 wt %. A mixture of different surfactants may also be used (e.g., two different cationic surfactants may be used together, or a non-ionic surfactant may be used with an anionic surfactant).

In another embodiment of the method, an emulsion of the monomer mixture is prepared in water, and then the emulsion is added to the pigment particle dispersion. In this embodiment, the monomer mixture is added to water prior to being mixed with the pigment dispersion. The monomer mixture is the discontinuous phase and the water is the continuous phase of the emulsion.

In still another embodiment of the method, the monomer mixture emulsion is formed, and then pigment particle cores are dispersed therein. In this embodiment, the dispersion of pigment particle cores in water is not formed, but rather the pigment particle cores are added directly to the monomer mixture emulsion.

It is generally desirable to include an initiator at some point during the formation of the combination of the monomer mixture and the pigments. When a water insoluble initiator (or monomer soluble initiator) is selected, this initiator may be added to the monomer mixture prior to emulsification. This is desirable to avoid phase separation, and heterogeneity of the initiator among the droplets in the emulsion. Examples of water soluble initiators include, but are not limited to potassium persulfate, ammonium persulfate, sodium persulfate, and those available from Wako Chemicals USA, Inc. (Richmond, Va.), such as, for example, VA-044 and VA-057. When a water soluble initiator is selected, this initiator may be added at any time during the process before polymerization is initiated. Examples of water insoluble initiators include 2,2-azobis(2-methylpropionitrile) and 1,1-azobis(cyclohexanecarbonitrile), and those available from Wako Chemicals USA, Inc. (Richmond, Va.), such as, for example, VA-70. The amount of these initiators generally ranges from about 0.2 wt % to about 10 wt % with respect to the total monomer content. More specific examples of suitable ranges for the initiator amount include from 1 wt % to 6 wt %, or from 3 wt % to 5 wt %. It is to be further understood that mixtures of the initiators may also be employed.

The mixture of the pigment dispersion and monomer mixture emulsion is then subjected to predetermined shear conditions. The monomers disclosed herein can be coated on the surface of particles under high shear conditions, such as those high shear conditions provided by sonication, milling, or microfluidization, as described in the publication “Preparation of Polymeric Nanocapsules by Miniemulsion Polymerization” by Franca Tiarks, Katharina Landfester and Markus Antonietti, published by Langmuir 2001, 17, pages 908-918, which is incorporated herein by reference. With this background in mind, it has been recognized that by dissolving the hydroxyl hydrophobes disclosed herein in a monomer mix, high shear conditions can likewise be used to apply these more viscous materials to the surface of a pigment particle, and thus, apply thicker coatings than by conventional polymer adsorption. Under these conditions, the discontinuous phase of the emulsion or microemulsion having both monomer and dissolved hydrophobes contained therein can be finely dispersed to nano-sized particles. At this size and under shear conditions, the nano-sized particles can become adhered to the surface of the pigment particle core upon collision therewith, thereby stabilizing the finely dispersed discontinuous phase on the surface of the pigments. In other words, a pigment and an aqueous emulsion of the monomer and dissolved hydrophobes can be sheared with sufficient intensity such that the monomer/hydrophobe disperses into nanodroplets capable of stable condensation on the pigment surface. A layer of monomer/hydrophobe builds on the pigment surface until the shear gradient surrounding each pigment is sufficient to strip off additional adsorbing monomer/hydrophobe mixture.

Furthermore, the sizing of each pigment particle can be conventionally produced through the shearing mechanism. The shear forces can be applied by ultrsonication, grinding, or microfluidization to reduce pigment aggregates, for example, from a few microns to the sub-micron range of 50 nm to 300 nm. As such, various sizes of polymer-encapsulated pigments can be prepared. The thickness of the polymer coating generally ranges from 2 nm to 100 nm in diameter, or from 5 nm to 60 nm, or from 10 nm to 40 nm.

After shearing is accomplished, the mixture is heated to a temperature sufficient to initiate polymerization of the monomers, thereby forming the polymer shell on the particle core. It is to be understood that the temperature at which polymerization initiation takes place will depend, at least in part, upon the initiation temperature of the initiator used. In a non-limiting example, such thermal initiation takes place at a temperature ranging from about 35° C. to about 135° C. The mixture may be exposed to such temperatures for a time sufficient to complete polymerization and form the polymer layer having hydrophobes adhered thereto on the particle core. In a non-limiting example, the thermal initiation is accomplished for a time ranging from about 0.01 hours to about 48 hours.

In any of the embodiments disclosed herein, it is to be understood that the polymer encapsulated particles may have a bridging layer established between the pigment particle core and the polymer layer. Examples of such bridging layers are disclosed in U.S. Pat. No. 7,544,418 to Vincent et al., the contents of which is incorporated herein by reference. Very generally, the bridging layer includes a bridging component, which passivates the pigment particle core surface for application of the polymer layer. More particularly, the bridging component is a soluble material that is desolublized and deposited on the pigment particle core surface via a change in the environmental conditions, e.g., temperature, pH, etc., of the fluid of the pigment dispersion in which it is carried. In another embodiment, the surface of the pigment can include surface groups capable of reacting out, and a fast reacting monomer layer can be placed on such surface. In this alternative embodiment, the polymer layer, for example, may include slower reacting monomers that are inhibited by the retarding pigment surface groups. In still other embodiments, the pigment particle core may be coated through solvent extraction. In this case, an otherwise solid polymer can be dissolved with a solvent into an emulsion and coated on the pigment particle core surface under high shear. Once the polymer is adsorbed on the pigment surface in a liquid state (liquid by virtue of the solvent that is still present in the polymer), the solvent is extracted, e.g., heated, diluted with additional water, etc., so that the polymer resolidifies. Alternatively, an otherwise solid polymer may be melted to a liquid and mixed with hot water to form an emulsion. The polymer is then adsorbed on the pigment particle core surface, again usually with high shear, e.g. microfluidizer, sonicator, etc. Once coated on the pigment surface, the molten polymer is cooled to re-establish its solid form by cooling the mixture. It is to be understood that whatever technology is used to form the bridging layer, if the bridging layer is included, the polymer layer prepared in accordance with embodiments disclosed herein is applied directly to the bridging layer.

The encapsulated pigment particles may be incorporated into an ink formulation that is suitable for inkjet printing (i.e., thermal inkjet printing, piezoelectric inkjet printing, etc.). Generally, the encapsulated pigment particles are added to an ink vehicle, which includes water, and, in some instances, one or more co-solvents present in an amount up to 30 wt % of the total formulation, depending on the jetting architecture. Further, one or more non-ionic, cationic, and/or anionic surfactant may be present, generally in an amount up to 5.0 wt %. The balance of the formulation can be purified water, or other vehicle components known in the art, such as biocides, viscosity modifiers, materials for pH adjustment, sequestering agents, preservatives, and the like. In many embodiments, the liquid vehicle is predominantly water.

Classes of co-solvents that may be used include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs of polyethylene glycol alkyl ethers, N-alkyl caprolactams, unsubstituted caprolactams, both substituted and unsubstituted formamides, both substituted and unsubstituted acetamides, and the like. Specific examples of solvents that may be used include trimethylolpropane, 2-pyrrolidinone, and 1,5-pentanediol.

One or more of many surfactants may also be used in the ink vehicle, non-limiting examples of which include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. It is to be understood that the surfactant that is described as being usable in the liquid vehicle is not the same as the surfactant that is described for use in preparation of the polymer encapsulated pigments, though many of the same surfactants can be used for either purpose.

Furthermore, various other additives may be employed to optimize the properties of the ink formulation for specific applications. Examples of these additives include those added to inhibit the growth of harmful microorganisms. These additives may be biocides, fungicides, and other microbial agents, which are routinely used in ink formulations. Examples of suitable microbial agents include, but are not limited to, Nuosept (Nudex, Inc.), Ucarcide (Union carbide Corp.), Vancide (R.T. Vanderbilt Co.), Proxel (ICI America), and combinations thereof.

Sequestering agents, such as EDTA (ethylene diamine tetra acetic acid), may be included to eliminate the deleterious effects of heavy metal impurities, and buffer solutions may be used to control the pH of the ink. When included, up to 2.0 wt %, for example, may be used. Viscosity modifiers and buffers may also be present, as well as other additives known to those skilled in the art to modify properties of the ink as desired. Such additives can be present in amounts up to 20.0 wt %.

The inkjet ink formulation includes from about 0.5 wt % to about 40 wt % of the polymer encapsulated particles. In non-limiting examples, the polymer encapsulated particles are present in amounts ranging from about 2 wt % to about to 15%, or from about 3 wt % to about 10 wt %.

Concentrations, amounts, and other numerical data may be expressed or presented herein in a range format. It is to be understood that such a range format is used for convenience and brevity, and thus, should be interpreted in a flexible manner to include the numerical values explicitly recited as the limits of the range, as well as the individual numerical values or sub-ranges encompassed within that range as if each numerical value and sub-range is explicitly recited. To illustrate, a concentration range of “0.1 wt % to 5 wt %” should be interpreted to include not only the explicitly recited concentration of 0.1 wt % to 5 wt %, but also include individual concentrations and the sub-ranges within the indicated range. Thus, included in this numerical range are individual concentrations, such as 1 wt %, 2 wt %, 3 wt %, and 4 wt %, and sub-ranges, such as from 0.1 wt % to 1.5 wt %, 1 wt % to 3 wt %, from 2 wt % to 4 wt %, from 3 wt % to 5 wt %, etc. This same principle applies to ranges reciting one numerical value. For example, a range recited as “up to 5 wt %” should be interpreted to include all values and sub-ranges between 0 wt % and 5 wt %.

To further illustrate embodiment(s) of the present disclosure, the following example is given herein. It is to be understood that this example is provided for illustrative purposes and is not to be construed as limiting the scope of the disclosed embodiment(s).

### Example 1

### Pigment Dispersion

82.4 g of PRINTEX® 25 (from Degussa) was mixed with 6.59 g of LUTENSOL® AT 50. This mixture was stirred well with 906 mL of water (906 ml) for 17 hours. The mixture was ultrasonicated at 90% amplitude for 1.5 hours while cooling the solution with water. It was again sonicated for another 0.5 hours.

### Example 2

### Encapsulated Particle in the Presence of 2-Hexadecanol with Styrene and Divinylbenzene

An emulsion can be formed from styrene and divinylbenzene (present in the ratio of 98:2, a total of 3 g), 2-hexadecanol (0.09 g) and azobisisobutyronitrile (0.2 g) with water (15 ml) containing LUTENSOL® AT50 (0.075 g). This is added to 120 g of the pigment dispersion from Example 1. This mixture is microfluidized for three cycles to generate a uniform dispersion. A single cycle involves the whole solution being completely passed through the interacting chamber. At the beginning of the microfluidization process, the dispersion may not be uniform because of the particle size distribution of the pigments. It is believed that the mixture will become homogeneous if exposed to enough cycles. Further, it is believed that for this example, three cycles will result in a homogeneous mixture/solution. The homogeneous solution will be collected and purged with nitrogen. This mixture may be heated to 60° C. for 24 hours to initiate and complete polymerization; and may then be filtered with 200 mesh filter to obtain encapsulated particles.

### Example 3

### Encapsulated Particle in the Presence of 2-Hexadecanol with a Mixture of Monomers

Example 2 may be repeated, except the monomer set of Example 2 may be replaced with styrene, hexyl methacrylate, 3-vinylbenzoic acid and ethylene glycol dimethacrylate, present in the ratio of 20/71/8/1 in the same amount (i.e., 3 g). This monomer mixture may undergo similar conditions as described in Example 2 to obtain encapsulated particles with a copolymer coating obtained from the mixture of monomers.

While several embodiments have been described in detail, it will be apparent to those skilled in the art that the disclosed embodiments may be modified. Therefore, the foregoing description is to be considered exemplary rather than limiting.

What is claimed is:

1. An encapsulated pigment particle, comprising:
a pigment particle core; and
a polymer encapsulation layer established on a surface of the pigment particle core, the polymer encapsulation layer including:
a polymer; and
a hydrophobe integrated with the polymer, the hydrophobe having the following structure: 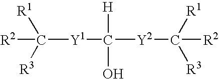
wherein R¹ and R² are independently selected from H, a linear or branched alkyl group with its number of carbons ranging from 1 to 40, and an aryl group with its number of benzene rings ranging from 1 to 10; wherein R³ is H or OH; wherein Y¹ is selected from a bond, O, a linear or branched alkylene group with its number of carbons ranging from 1 to 40, and an arylene group with its number of benzene rings ranging from 1 to 10; and wherein Y² is selected from a bond and (CH₂)ₙ, where n=0 to 40.

2. The encapsulated pigment particle as defined in claim 1 wherein the hydrophobe is physically present with the polymer as a single phase.

3. The encapsulated pigment particle as defined in claim 1 wherein the hydrophobe is selected from 2-hexadecanol; 1,2-hexadecanediol; 1,16-hexadecanediol; 1,2-tetradecanediol; 1,14-tetradecanediol; 1,2-dodecanediol; 1,12-dodecanediol; 2-octanol; 3-octanol; and 2,5-hexanediol.

4. The encapsulated pigment particle as defined in claim 1 wherein a diameter of the pigment particle core ranges from about 50 nm to about 300 nm, and wherein a thickness of the polymer encapsulation layer ranges from about 2 nm to about 100 nm.

5. An inkjet ink formulated with a plurality of the encapsulated pigment particles as defined in claim 1 dispersed therein.

6. The inkjet ink as defined in claim 5 wherein the encapsulated pigment particles are dispersed in an ink vehicle.

7. The inkjet ink as defined in claim 5 wherein the encapsulated pigment particles are present in the ink in an amount ranging from about 0.5. wt % to about 40 wt % of a total weight of the ink.

8. A method for forming encapsulated pigment particles, comprising:
dispersing a plurality of pigment particles and a monomer mixture in water to form a dispersion, the monomer mixture including:
at least one monomer; and
a hydrophobe having the following structure: 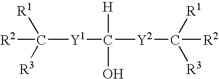
wherein R¹ and R² are independently selected from H, a linear or branched alkyl group with its number of carbons ranging from 1 to 40, and an aryl group with its number of benzene rings ranging from 1 to 10; wherein R³ is H or OH; wherein Y¹ is selected from a bond, O, a linear or branched alkylene group with its number of carbons ranging from 1 to 40, and an arylene group with its number of benzene rings ranging from 1 to 10; and
wherein Y² is selected from a bond and (CH₂)ₙ, where n=0 to 40;
exposing the dispersion to predetermined shear conditions such that the monomer mixture coats each of the plurality of pigment particles; and
heating the coated pigment particles to polymerize the at least one monomer in the monomer mixture and to form a polymer encapsulation layer on each of the pigment particles.

9. The method as defined in claim 8 wherein the plurality of pigment particles is dispersed in the water prior to addition of the monomer mixture such that a pigment dispersion is formed, and wherein the method further comprises:
forming an emulsion of the monomer mixture in water; and
adding the emulsion to the pigment dispersion.

10. The method as defined in claim 9 wherein prior to forming the emulsion, the method further comprises selecting the hydrophobe from a group consisting of 2-hexadecanol; 1,2-hexadecanediol; 1,16-hexadecanediol; 1,2-tetradecanediol; 1,14-tetradecanediol; 1,2-dodecanediol; 1,12-dodecanediol; 2-octanol; 3-octanol; and 2,5-hexanediol.

11. The method as defined in claim 8 wherein the monomer mixture is present in the water prior to dispersing the plurality of pigments therein.

12. The method as defined in claim 8 wherein the monomer mixture includes at least one hydrophobic monomer present in an amount up to 98% of total monomers in the monomer mixture and at least one an acidic monomer present in an amount ranging from about 0.1 wt % to about 30 wt % of the total monomers in the monomer mixture; wherein the at least one hydrophobic monomer is selected from the group consisting of methyl methacrylate, ethyl methacrylate, propyl methacrylate, butyl methacrylate, hexyl methacrylate, 2-ethylhexyl methacrylate, lauryl methacrylate, octadecyl methacrylate, isobornyl methacrylate, vinyl acetate, methyl acrylate, ethyl acrylate, propyl acrylate, butyl acrylate, hexyl acrylate, 2-ethylhexyl acrylate, lauryl acrylate, octadecyl acrylate, isobornyl acrylate, styrene, and combinations thereof; and wherein the at least one acidic monomer is selected from the group consisting of acrylic acid, methacrylic acid, itaconic acid, maleic acid, vinyl benzoic acid, styrenesulfonates, derivatives thereof, and combinations thereof.

13. The method as defined in claim 8, further comprising adding a surfactant to the dispersion.

14. The method as defined in claim 8, further comprising adding a water insoluble initiator to the monomer mixture prior to dispersing the monomer mixture in the water.

15. The method as defined in claim 8, further comprising adding a water soluble initiator to the dispersion prior to heating.

16. The method as defined in claim 8 wherein the predetermined shear conditions are achieved via sonication, milling, or microfluidization.

17. The method as defined in claim 8 wherein the monomer mixture further includes a copolymer dissolved therein.

18. A method for forming encapsulated pigment particles, comprising:
forming a pigment dispersion including a plurality of pigments and a surfactant in water;
forming an emulsion, in water, of at least one hydrophobic monomer, at least one acidic monomer, a surfactant, an initiator, and at least one hydrophobe having the following structure: 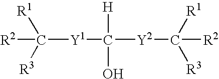
wherein R¹ and R² are independently selected from H, a linear or branched alkyl group with its number of carbons ranging from 1 to 40, and an aryl group with its number of benzene rings ranging from 1 to 10; wherein R³ is H or OH; wherein Y¹ is selected from a bond, O, a linear or branched alkylene group with its number of carbons ranging from 1 to 40, and an arylene group with its number of benzene rings ranging from 1 to 10; and wherein Y² is selected from a bond and (CH₂)ₙ, where n=0 to 40;
adding the emulsion to the pigment dispersion;
exposing the emulsion and pigment dispersion mixture to sonication, milling, or microfluidization, whereby the components of the emulsion coat the plurality of pigment particles; and
heating the coated pigment particles to initiate polymerization of the at least one hydrophobic monomer and the at least one acidic monomer, thereby forming a polymer encapsulation layer on a surface of each of the pigment particles.

19. The method as defined in claim 18 wherein prior to forming the emulsion, the method further comprises selecting the at least one hydrophobe from a group consisting of 2-hexadecanol; 1,2-hexadecanediol; 1,16-hexadecanediol; 1,2-tetradecanediol; 1,14-tetradecanediol; 1,2-dodecanediol; 1,12-dodecanediol; 2-octanol; 3-octanol; and 2,5-hexanediol.

20. The method as defined in claim 18 wherein the at least one hydrophobic monomer is present in an amount up to 98% of total monomers in the emulsion and the at least one acidic monomer is present in an amount ranging from about 0.1 wt % to about 30 wt % of the total monomers in the emulsion; wherein the at least one hydrophobic monomer is selected from the group consisting of methyl methacrylate, ethyl methacrylate, propyl methacrylate, butyl methacrylate, hexyl methacrylate, 2-ethylhexyl methacrylate, lauryl methacrylate, octadecyl methacrylate, isobornyl methacrylate, vinyl acetate, methyl acrylate, ethyl acrylate, propyl acrylate, butyl acrylate, hexyl acrylate, 2-ethylhexyl acrylate, lauryl acrylate, octadecyl acrylate, isobornyl acrylate, styrene, and combinations thereof; and wherein the at least one acidic monomer is selected from the group consisting of acrylic acid, methacrylic acid, itaconic acid, maleic acid, vinyl benzoic acid, styrenesulfonates, derivatives thereof, and combinations thereof.
